(19) United States
(12) Patent Application Publication
(10) Pub. No.: US 2021/0239183 A1
(43) Pub. Date: Aug. 5, 2021

(54) EPOXY-LESS REMOTELY OPERATED VEHICLE TERMINATION

(71) Applicant: PMI Industries, Inc., Cleveland, OH (US)

(72) Inventors: Terry Zahuranec, North Olmsted, OH (US); Tyler Burger, Euclid, OH (US); Benjamin Neumann, Westlake, OH (US); Jay C. Marino, South Euclid, OH (US)

(21) Appl. No.: 17/269,658

(22) PCT Filed: Aug. 21, 2019
(86) PCT No.: PCT/US2019/047539

§ 371 Date: Feb. 19, 2021

Related U.S. Application Data
(60) Provisional application No. 62/720,204, filed on Aug. 21, 2018.

(51) Int. Cl. F16G 11/02; F16G 11/04; H01R 13/523; H01R 13/58; H02G 15/06; F16B 9/00

(52) U.S. Cl. CPC F16G 11/025; F16G 11/04; F16B 9/054; H01R 13/5825; H02G 15/06; H01R 13/523

(57) ABSTRACT

An improved method and apparatus for securing remotely operated vehicles (ROVs) and other similar underwater equipment that require an umbilical power and/or communications cable to a docking collar termination.

This application claims the priority benefit of U.S. provisional application Ser. No. 62/720,204, filed, Aug. 21, 2018, the entire disclosure of which is incorporated herein by reference.

### BACKGROUND

The present disclosure relates to devices and methods for attaching cables to an underwater device. It finds particular application, for example, in conjunction with attaching umbilical cables to Remotely Operated (Underwater) Vehicles (ROV), and will be described with particular reference thereto. However, it is to be appreciated that the present exemplary embodiment is also amenable to other like applications.

ROVs may be used for underwater survey missions such as mapping. The ROV is typically connected to a ship by a series of cables. The ROV is supplied with at least one of (for example) electrical power, hydraulic power, control signals, etc., via an umbilical cable from a surface platform or surface vessel (ship). The umbilical cable may also provide a mechanical link between a surface vessel and the ROV. In ROV operations, an epoxy-potted termination is normally located on the end of the umbilical cable and includes features to interface with a latching mechanism on the ship, specifically a launch and recovery system.

Installation times on vessels to terminate ROV umbilical cables can take 12-24 hours which can incur large down-time costs. An improved design with no epoxy can alleviate the expensive downtime and shorten it to 1-2 hours. Also, termination size is limited and normal helical rod designs are longer (greater than 27.6″ (700 mm) than the customers require to lift the ROV onto the deck with the launch and recovery system.

It would be advantageous to replace these terminations with a no mix “epoxy-less” version or possibly entirely eliminating epoxy from the termination to save installation time in the field while fitting in the needed physical size parameters through modifications and re-engineering technology.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

A termination assembly for securing an associated cable assembly is provided.

The termination assembly includes a cable and armor wires received over a perimeter of the cable. An annular docking housing includes an internal cavity. A retainer is received in the docking cavity, and has first and second ends axially spaced from one another and a contoured passage extending through the retainer from the first end to the second end. The contoured passage is dimensioned to receive the associated cable assembly therein. A retainer nut secures the retainer within the docking housing cavity. An anti-rotation mechanism operatively associated with the docking housing and the retainer permits relative axial sliding movement and prevents relative rotation between the docking housing and the retainer.

The anti-rotation mechanism includes an axial slot in an external surface of the retainer that receives a set-screw or pin therein.

The pin includes a threaded region that cooperates with mating, threaded recesses.

An insert is dimensioned for receipt in the contoured passage at a radial location between the associated cable and the armor wires of the associated cable assembly.

The insert includes a contoured external surface that mates with the contoured passage of the retainer.

The insert includes a depressed swaging area or region on an external surface thereof that accommodates inward movement of the associated armor wires toward the associated cable to take up slack of the associated armor wires and enhance securing the associated cable assembly in the termination assembly.

Grit is provided on at least one of an inner surface of (i) the retainer that forms the contoured passage and the (ii) insert.

The grit is sized between about 100-400 microns.

The grit in one embodiment is aluminum oxide (Al₂O₃).

A micro-encapsulated no-mix epoxy coating provided over the grit.

The retainer is configured for receipt around the associated cable assembly.

The retainer includes first and second retaining members disposed in axially spaced relation.

The docking housing includes a threaded surface at one end to engage an associated threaded surface of an associated bending strain relief assembly received over the associated cable assembly.

First and second legs extend axially in parallel arrangement from the docking housing.

First and second bosses extend from an external surface of the docking housing received in a mating, boss-receiving recess in the first and second legs, respectively.

A method of securing an associated cable assembly, that includes a cable and armor wires received over a perimeter of the cable, to an associated surface is provided.

The method includes providing an annular docking housing that includes an internal cavity; positioning a retainer having first and second ends axially spaced from one another and a contoured passage extending therethrough over the associated cable assembly; inserting the retainer with the associated cable assembly into the docking cavity; securing the retainer within the docking housing cavity; and providing an anti-rotation mechanism that permits relative axial sliding movement and prevents relative rotation between the docking housing and the retainer.

First and second bosses extend from an external surface of the docking housing received in a mating, boss-receiving recess in the first and second legs, respectively.

### BRIEF DESCRIPTION OF THE DRAWINGS

The following is a brief description of the drawings, which are presented for the purposes of illustrating the exemplary embodiments disclosed herein and not for the purposes of limiting same.

FIG. 1 illustrates a perspective view of a docking termination device in accordance with the present disclosure.

FIG. 2 illustrates a longitudinal cross-sectional view of a docking termination device.

FIG. 3 illustrates a perspective view of a docking termination housing with an ROV mounting portion.

FIG. 4 illustrates a side perspective view of a docking termination housing with the legs removed.

FIG. 5 illustrates a perspective view of an insert (i.e., adjacent, first and second insert portions).

FIG. 6 illustrates an elevational view of the insert of FIG. 5.

FIG. 7 illustrates a longitudinal cross-sectional view of the insert.

FIG. 8 illustrates a cross-sectional perspective view of a first or front retainer portion of a docking termination device.

FIG. 9 illustrates a cross-sectional perspective view of a second or rear retainer of a docking termination device.

FIG. 10 illustrates an enlarged, longitudinal cross-sectional view of the docking termination device.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/components/steps and permit the presence of other ingredients/components/steps. However, such description should be construed as also describing compositions, articles, or processes as “consisting of” and “consisting essentially of” the enumerated ingredients/components/steps, which allows the presence of only the named ingredients/components/steps, along with any impurities that might result therefrom, and excludes other ingredients/components/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

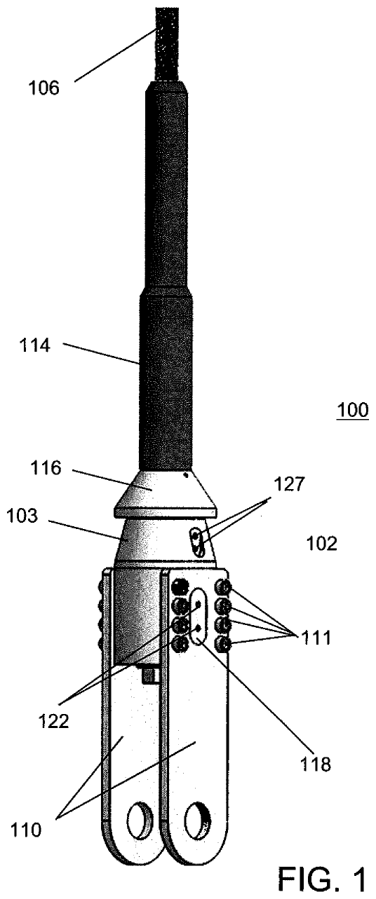

With reference to FIGS. 1-4, a docking termination assembly or device 100 includes a housing 102. The housing 102 is an annular, preferably one-piece component and includes a cavity 101 formed therein with an opening 104 at a first end 105A that communicates with the cavity 101. The housing 102 includes a tapered docking nose 116 adjacent the first end 105A, an intermediate region 103, and a mount region 115 adjacent to a second end 105B. The mount region 115 of the housing 102 is substantially cylindrical in shape with the exception of two opposing flat ROV mount receiving surfaces 117.

The housing 102 is preferably a durable metal material (e.g., stainless steel is one desired material due to its strength and non-corrosive features) that is able to withstand the desired load requirements and end use environment. More preferred embodiments use 316 or 17-4 stainless steel to form the housing. The housing 102 may be a single continuous component or may be constructed from multiple pieces that would be joined together and being a multi-piece component may facilitate assembly over the associated umbilical cable). For example, and without limitation, the housing 102 may include two symmetric halves that are secured together by a plurality of fasteners (not shown).

The housing 102 is adapted to receive an associated umbilical cable 106 therethrough. That is, the umbilical cable 106 extends through the cavity 101 via opening 104 at the first end 105 of the housing 102. The umbilical cable 106 has a first end (not shown) that is attached to a surface vessel such as a ship and a second end 109 that is designated to be attached to an ROV via the docking termination device 100. The umbilical cable 106 is a bundle of flexible cables 108 packaged within a protective sheath. The umbilical cable 106 includes an outer armor layer 107 such that one or a plurality of interior cables 108 of the umbilical cable 106 are protected from the marine environment and are able to withstand heavy loads without unduly compressing the umbilical cable gripped by the armor wires. The armor layer 107 may be composed of individual armor rods or wires (typically a series of helically shaped armor wires as are conventionally used in the industry). The umbilical cable armor 107 or plurality of steel wires are helically wrapped around the bundle of interior cables 108.

The docking termination device 100 may also include replaceable ROV mounting legs 110. The ROV mounting legs 110 provide a mechanical connection between the housing 102 and an ROV (not shown). The ROV mounting legs 110 are adapted to be secured to the mount region 115 of the housing 102. That is the ROV mounting legs 110 are received on planar ROV mount receiving surfaces 117 and connect to the housing 102 by a plurality of fasteners 111, e.g. threaded fasteners such as bolts. In some embodiments, the threaded fasteners 111 are adapted to engage a plurality of threaded sockets 112 located on the ROV mount receiving surfaces 117 of housing 102 through corresponding apertures (not shown) of the ROV mounting legs 110. The ROV mounting legs 110 are interchangeable allowing different mounting styles to be used for installation of a variety of ROV's to the termination device.

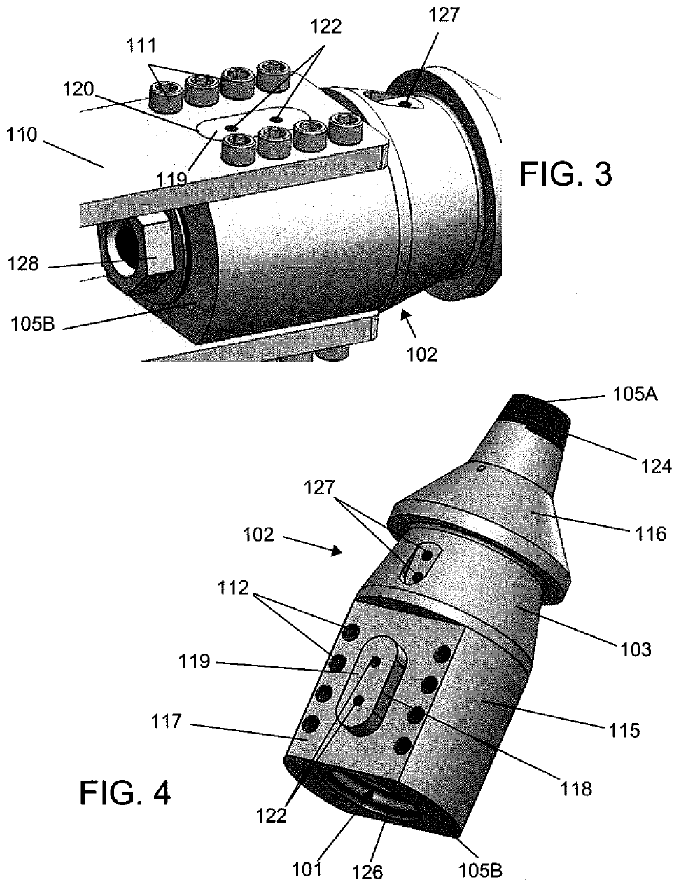

The housing 102 may also include leg alignment projections or bosses 118 dimensioned for receipt in corresponding openings in the legs in order to provide further strength to the attachment arrangement. The leg alignment and reinforcing projection 118 is a raised portion of the ROV mount receiving surface 117 and is configured for receipt in a corresponding mount aperture 120 of the ROV mount portions 110. The leg alignment projections 118 may include a plurality of threaded recesses or bores 122 configured to receive set screws as described in greater detail below. Preferably, the surfaces 119 of the ROV mount do not extend above the legs, i.e., a generally flush (FIG. 3).

The docking termination device 100 is preferably designed for attachment with a bending strain relief (BSR) 114. The BSR 114 is commonly a urethane, sleeve-like structure with or without encapsulated strengthening portions in the urethane body that is used to limit the amount of deflection or bending of the umbilical cable 108 received in the BSR, typically allowing progressive bending or limiting the amount of bending of the cable as the cable extends from a mounting region. The BSR 114 includes a throughbore 113 configured or dimensioned to receive the umbilical cable 106. The BSR 114 relieves strain on the umbilical cable 106 by resisting bending of the inserted umbilical cable.

The BSR 114 is attached to the housing 102 via the docking nose 116. In some embodiments, the BSR 114 is removably secured to the housing 102 at the docking nose 116. The attachment of the BSR 114 to the housing 102 may be made by one of a variety of attachment structures. One preferred attachment includes exterior threads 124 that are adapted to engage interior threads 125 of the BSR 114. The engaged threads 124, 125 provide a secure mechanical connection between the BSR 114 and housing 102 and effectively seal the interior cavity 101 of the device 100 from the underwater environment.

The housing 102 has a second end 105B that includes a recess 126 configured to accept a retainer nut 128. The retainer nut 128, when inserted into the recess 126, abuts and applies a retaining force in the direction toward the first end 105A. That is, an interior thrust washer 129 is urged into abutting contact with a retainer, specifically a rear retainer portion 142 (described in greater detail below) upon threaded engagement of the retainer nut 128 into the housing 102.

The housing 102 also includes an intermediate middle region 103 located between the docking nose 116 and mounting region 115. In some embodiments, the intermediate region 103 is conically shaped. That is, the diameter of the intermediate region 103 increases from an end adjacent the docking nose 116 to an end adjacent the mounting region 115. The intermediate region 103 also includes a plurality of threaded openings/recesses 127. The threaded recesses 127 are configured to receive anti-rotation members or set screws as described in greater detail below.

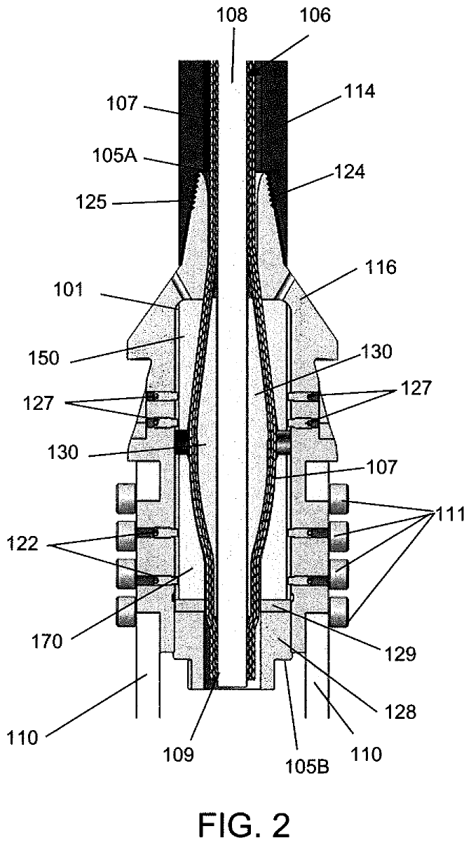

With reference to FIGS. 2 and 5-7, the termination device 100 also includes an internal insert 130. The insert 130 is preferably a unitary, one-piece component (although that does not preclude a multi-piece component) that includes a cylindrically hollow bore 131 that is adapted to receive the interior cable(s) 108 of the umbilical cable 106. The insert 130 is dimensioned for receipt between the cable(s) 108 and the armor wires 107, specifically the armor wires are received over an outer surface 132 of the insert. Thus, the insert 130 is securely positioned between the interior cable 108 and armor 107 of the umbilical cable 106. In some embodiments, the insert 130 is a replaceable element that may be shaped to accommodate umbilical cables 106 of varying sizes.

In some preferred arrangements, the outer surface 132 of the insert 130 is coated with a grit or grit like material. One example of such material, without limitation, are particles of Al₂O₃. The particles are preferably between 100 microns to 400 microns in diameter. These particles may be applied to the surface 132 by plasma spraying, for example, and thereby fixed to the surface. In some embodiments, a micro-encapsulated epoxy is received over the grit and the micro-encapsulated epoxy is set in place (without mixing and setting over an extended period of time in a typical epoxy type of application). The grit and/or epoxy-less or micro-encapsulated epoxy increases the adhesion/gripping between the armor 107 to the insert 130.

The insert 130 preferably includes a first taper portion 134 and second taper portion 135 that each gradually increase in radial dimension as they extend inwardly from opposite ends of the insert. The diameter of first taper portion 134 decreases along its length toward a first insert end 136. In some embodiments and as shown, the first taper portion 134 is linearly tapered. The second taper portion 135 tapers in an opposite direction from the first taper portion 134. That is, the diameter of the second taper portion 135 decreases along its length toward a second insert end 137. The insert has a more complex central, outer surface conformation that includes a constant or substantially constant diameter portion 138 (swaging area) that merges into the reducing, tapering portion 135.

In some embodiments, the insert 130 further includes a reduced diameter, second substantially cylindrical portion 139 adjacent the second end. The dimension or diameter of the second cylindrical portion 139 is less than the diameter of the first cylindrical portion 134.

In some embodiments, the insert 130 includes a circumferentially continuous swage depression region 140 around a circumference of the insert 130. The swage depression region 140 is preferably centrally located on the insert 130, and preferably the swage depression region 140 is located between the first taper portion 134 and second taper portion 135. In some embodiments, the swage depression region 140 is located between the first cylindrical portion 138 and first taper portion 134.

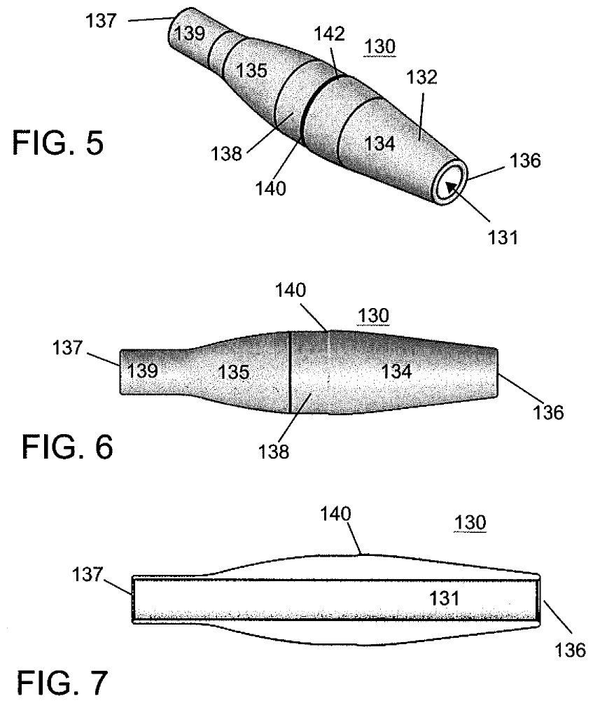

As illustrated in FIGS. 4 and 5, the swage depression area 140 is shaped to receive armor wires 107 of the umbilical cable 106 when the armor wires are urged inwardly during make-up of the termination device, thereby deforming or swaging the armor wires into the swage depressed area takes up any slack in the armor wire and thus provides a more secure locking of the armor wires. The rear retainer 170, described in more detail below, urges the armor wires 107 into the swage depression area 140.

With reference to FIGS. 2 and 7, the termination device 100 includes a retainer that includes a first or front retainer portion 150 conformably shaped and configured for placement within the housing cavity 101. The cavity 101 is preferably a cylindrically shaped cavity and the front retainer portion 150 is correspondingly cylindrically shaped. That is, the diameter 152 of the outside surface 154 of the front retainer portion 150 is substantially constant.

The front retainer portion 150 includes a bore 156. The front retainer portion bore 156 includes an interior diameter 158 that generally increases along the length of the front retainer portion 150 from a first end 153 to a second end 155. The bore 156 is shaped to conform to the external shape of the insert 130. That is, the bore 156 of the front retainer portion 150 is shaped to surround/engage the front taper portion 134 of the insert 130. In this way, the front retainer portion 150 is configured to secure the umbilical cable 106 within the housing 102 by securing the umbilical cable armor 107 between the outside surface 132 of the insert 130 and interior surface 157 defining the bore 156 of the front retainer portion 150. In some embodiments, the front retainer portion 150 is a single-piece, replaceable component (although multi-piece retainer portions are also contemplated) where different sized components may be shaped or dimensioned to accommodate umbilical cables 106 of varying sizes.

In some embodiments, the interior surface 157 forming the bore 156 of the front retainer portion 150 is coated with a grit or grit-like like material to enhance gripping. One example of such a material (without limiting to this specific material) are particles of Al₂O₃. The particles may be between to 100 microns to 400 microns in diameter. These particles may be applied to the surface 157 by plasma spraying. Thereafter, the grit is covered with a micro-encapsulated epoxy. In some embodiments, the micro-encapsulated epoxy need not be mixed and required to set or cure for an extended period of time, but instead is a small amount where the encapsulated material is exposed when burst under the make-up forces and cures in-situ.

The front retainer portion 150 preferably includes elongated slots 160 located diametrically on the front retainer portion. The elongated slots 160 are shallow, preferably axially extending depressions formed in the outer surface 154 of the retainer portion and that extend from the first end 153 to the second end 155. The elongated slots 160 are adapted to receive the nose ends of set-screws inserted through radially extending boreholes 127 of the housing 102. The set-screws extend from the surface of the housing 102 and into the one of the elongated slots 160 in order to prevent the front retainer portion 150 from rotating within the cavity 101.

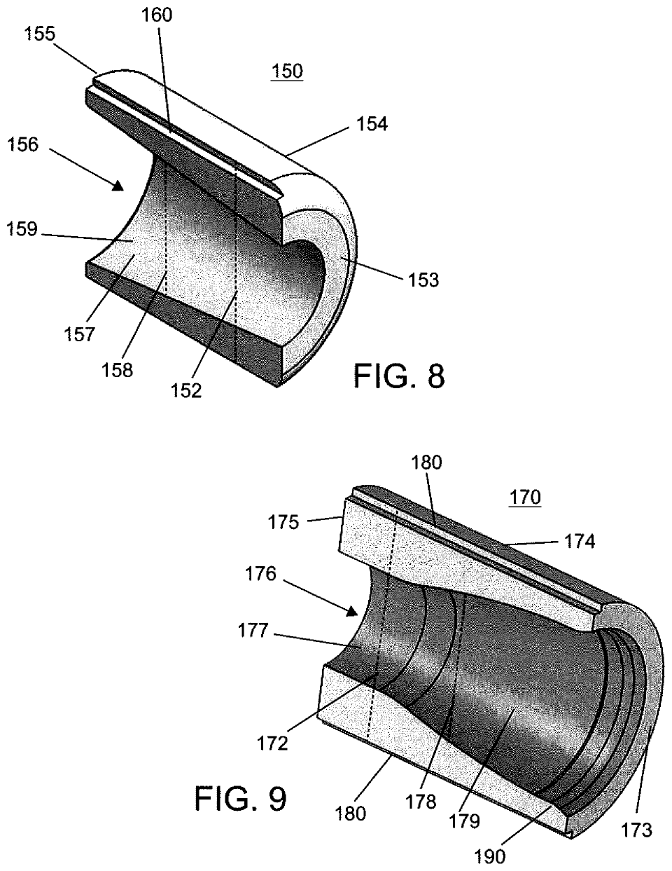

With reference to FIGS. 2 and 8, the termination device 100 likewise includes a rear retainer portion 170 conformably shaped and configured for placement within the housing cavity 101. In some embodiments, the cavity 101 is a cylindrically shaped cavity and the rear retainer portion 170 is similarly, correspondingly cylindrically shaped. That is, the diameter 172 of the outside surface 174 is substantially constant.

The rear retainer portion 170 includes a rear retainer bore 176. The rear retainer bore 176 includes an inner diameter 178 that decreases along the length of the rear retainer portion 170 from a first end 173 to a second end 175. The rear retainer portion bore 176 is shaped to conform to the external shape of the insert 130. That is, the bore 176, is correspondingly shaped to wrap around/engage the rear taper portion 135 of the insert portion 130. In this way, the rear retainer portion 170 is configured to secure the umbilical cable 106 within the housing 102 by securing the umbilical cable armor 107 between the outside surface 132 of the insert 130 and interior surface 177 of the rear retainer bore 176.

The interior surface 177 of the front retainer bore 176, is coated with a grit or grit-like material. One example of such material are particles of Al₂O₃. The particles may preferably be between to 100 microns to 400 microns in diameter. These particles may be applied to the surface, for example, by plasma spraying and then covered with a micro-encapsulated epoxy. The micro-encapsulated epoxy is ideally positioned where the epoxy aids in gripping and sealing in the termination device.

In a manner similar to the front retainer portion, the rear retainer portion 160 includes elongated slots 180. The elongated slots 180 are axially extending shallow depressions in the outer surface 174, extending from a first end 173 to a second end 175. The elongated slots 180 are adapted to receive radially inner or nose ends of set-screws inserted through boreholes 122 of the alignment projections 118. The set-screws extend from the surface 119 of the housing 102 and into one of the corresponding elongated slots 180. The set-screws (not shown) prevent the rear retainer portion 170 front rotating within the cavity 101. In some embodiments, the rear retainer portion 160 is a replaceable component that may be shaped to accommodate umbilical cables 106 of varying sizes.

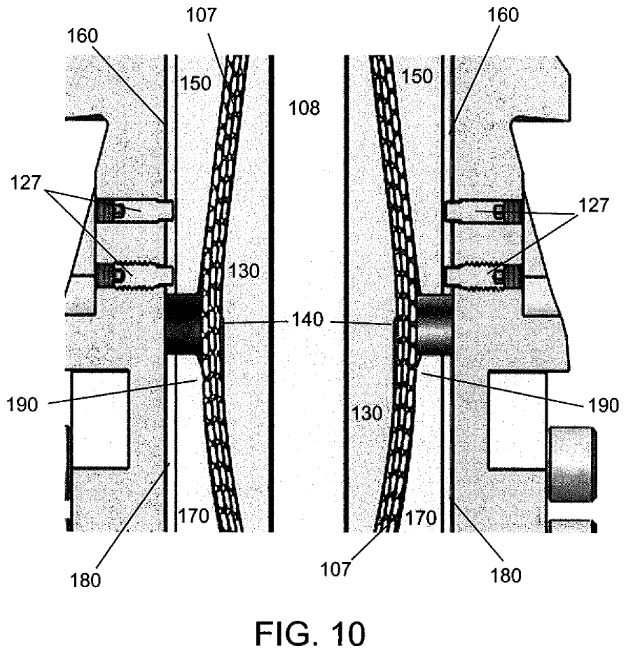

With reference to FIGS. 9 and 10, the rear retainer portion 170 includes a circumferentially continuous interior bulge 190 around an inner circumference of the rear retainer bore 176. The shape of the rear retainer portion 170 (i.e., the interior bulge 190) depresses or swages the armor wire 107 into the swage depression area 140 of the insert 130. This causes the insert to take up any slack in the armor wire 107 thus providing a more secure locking of the armor wires.

The assembled termination device 100, is capable of, for example, a safe working load of 25 tons (50,000 lbs.) and a maximum breaking load of 75 tons (150,000 lbs.). The overall length of the housing is minimized by the present design to about 1200 mm. The exemplary embodiments, describe an epoxy-less design, meaning that epoxy need not be mixed and cured in the traditional manner but instead is either cured in-situ, or in some instances many not be needed to aid in gripping and sealing the cable armor 107. The micro-encapsulated epoxy is also used in the device to adhere grit particles to contact surfaces. Thus, when attaching an umbilical cable 106 to the termination device 100, the wait time previously needed to allow the epoxy to cure is no longer needed. This allows for an installation time of only a few hours.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A termination assembly for securing an associated cable assembly, that includes a cable and armor wires received over a perimeter of the cable, to an associated surface, the termination assembly comprising:
an annular docking housing that includes an internal cavity;
a retainer received in the docking cavity, the retainer having first and second ends axially spaced from one another and a contoured passage extending through the retainer from the first end to the second end, the contoured passage dimensioned to receive the associated cable assembly therein;
a retainer nut for securing the retainer within the docking housing cavity; and
an anti-rotation mechanism operatively associated with the docking housing and the retainer that permits relative axial sliding movement and prevents relative rotation between the docking housing and the retainer.

2. The termination assembly of claim 1 wherein the anti-rotation mechanism includes an axial slot in an external surface of the retainer that receives a pin therein.

3. The termination assembly of claim 2 wherein the pin includes a threaded region that cooperates with mating, threaded recesses.

4. The termination assembly of claim 1 further comprising an insert dimensioned for receipt in the contoured passage at a radial location between the associated cable and the armor wires of the associated cable assembly.

5. The termination assembly of claim 4 wherein the insert includes a contoured external surface that mates with the contoured passage of the retainer.

6. The termination assembly of claim 5 wherein the insert includes a depressed swaging region on an external surface thereof that accommodates inward movement of the associated armor wires toward the associated cable to take up slack of the associated armor wires and enhance securing the associated cable assembly in the termination assembly.

7. The termination assembly of claim 4 further comprising grit provided on at least one of an inner surface of (i) the retainer that forms the contoured passage and the (ii) insert.

8. The termination assembly of claim 7 wherein the grit is sized between about 100-400 microns.

9. The termination assembly of claim 7 wherein the grit is aluminum oxide (Al₂O₃).

10. The termination assembly of claim 1 further comprising a micro-encapsulated no-mix epoxy coating provided over the grit.

11. The termination assembly of claim 1 wherein the retainer is configured for receipt around the associated cable assembly.

12. The termination assembly of claim 1 wherein the retainer includes first and second retaining members disposed in axially spaced relation.

13. The termination assembly of claim 1 wherein the docking housing includes a threaded surface at one end to engage an associated threaded surface of an associated bending strain relief assembly received over the associated cable assembly.

14. The termination assembly of claim 1 further comprising first and second legs extending axially in parallel arrangement from the docking housing.

15. The termination assembly of claim 14 further comprising fasteners for securing the legs to the docking housing.

16. The termination assembly of claim 14 further comprising first and second bosses extending from an external surface of the docking housing received in a mating, boss-receiving recess in the first and second legs, respectively.

17. A method of securing an associated cable assembly, that includes a cable and armor wires received over a perimeter of the cable, to an associated surface, the method comprising:
providing an annular docking housing that includes an internal cavity;
positioning a retainer having first and second ends axially spaced from one another and a contoured passage extending therethrough over the associated cable assembly;
inserting the retainer with the associated cable assembly into the docking cavity;
securing the retainer within the docking housing cavity; and
providing an anti-rotation mechanism that permits relative axial sliding movement and prevents relative rotation between the docking housing and the retainer.

18. The method of claim 17 wherein the anti-rotation mechanism includes an axial slot in an external surface of the retainer, and the method includes locating a pin through the docking housing for receipt in the axial slot.

19. The method of claim 18 wherein the method includes providing a threaded region on the pin that cooperates with a mating, threaded recess in the docking housing.

20. The method of claim 17 further comprising positioning an insert dimensioned for receipt in the contoured passage at a radial location between the associated cable and the armor wires of the associated cable assembly.

21. The method of claim 20 wherein the insert positioning step includes providing the insert with a contoured external surface that mates with the contoured passage of the retainer.

22. The method of claim 20 further comprising providing grit on at least one of an (i) inner surface of the retainer that forms the contoured passage and (ii) the insert.

23. The method of claim 22 further comprising using grit sized between about 100-400 microns.

25. The method of claim 22 further comprising using aluminum oxide (Al₂O₃) as the grit.

26. The method of claim 22 further comprising providing a micro-encapsulated no-mix epoxy coating over the grit.

27. The method of claim 17 further comprising swaging the associated armor wires inwardly toward the associated cable to take up slack of the associated armor wires and enhance securing the associated cable assembly in the termination assembly.

28. The method of claim 17 wherein the retainer includes first and second retaining members, and disposing the retaining members in axially spaced relation.

29. The method of claim 17 further comprising forming a threaded surface at one end of the docking housing to engage an associated threaded surface of an associated bending strain relief assembly received over the associated cable assembly.

29. The method of claim 17 further comprising joining first and second legs extending axially in parallel arrangement from the docking housing.

30. The method of claim 29 further comprising providing first and second bosses extending from an external surface of the docking housing received in a mating, boss-receiving recess in the first and second legs, respectively.
